(19) United States
(12) Patent Application Publication
(10) Pub. No.: US 2019/0156700 A1
(43) Pub. Date: May 23, 2019

(54) KEYBOARD FOR TEACHING OR TRAINING JAPANESE ROMAJI

(71) Applicant: Microsoft Technology Licensing, LLC., Redmond, WA (US)

(72) Inventors: Kae Kato, Ota-ku (JP); Rintaro Masuda, Kawasaki-shi (JP)

(21) Appl. No.: 15/820,213

(22) Filed: Nov. 21, 2017

(51) Int. Cl. G09B 19/06; G06F 3/0488; G06F 3/023; G09B 5/02; G09B 13/00

(52) U.S. Cl. CPC G09B 19/06; G06F 3/04886; G09B 13/00; G09B 5/02; G06F 3/0236

(57) ABSTRACT

A method can include displaying, by a user interface (UI) of a device, a first keyboard including first character keys, the first character keys each including a respective Roman character and corresponding Hiragana characters displayed thereon, in response to receiving one or more signals indicating a user selected a first character key of the first character keys, displaying a second keyboard including second character keys in place of the first keyboard, the second character keys including a respective Roman character and only one corresponding Hiragana character of the corresponding Hiragana characters displayed thereon, and in response to receiving one or more signals indicating a user selected a second character key of the second character keys, displaying the Hiragana character displayed on the second character at location of an insertion point and displaying, by the UI, the first keyboard.

### BACKGROUND STYLE

Japanese characters can be “Romanized” by applying a Latin script to the language. This Romanization results in a Kana language representation called Romaji, or Roman letters. Hepburn romanization may be the most well-known form of Romaji. Other Japanese language representations include Hiragana and Katakana.

### SUMMARY

This summary section is provided to introduce aspects of embodiments in a simplified form, with further explanation of the embodiments following in the detailed description. This summary section is not intended to identify essential or required features of the claimed subject matter, and the particular combination and order of elements listed this summary section is not intended to provide limitation to the elements of the claimed subject matter.

A method for training a user to type Romaji Japanese characters can include displaying, by a user interface (UI) of a device, a first keyboard including first character keys, the first character keys each including a respective Roman character and corresponding Hiragana characters displayed thereon. The method can further include, in response to receiving one or more signals indicating a user selected a first character key of the first character keys, displaying a second keyboard including second character keys in place of the first keyboard, the second character keys including a respective Roman character and only one corresponding Hiragana character of the corresponding Hiragana characters displayed thereon. The method can further include, in response to receiving one or more signals indicating a user selected a second character key of the second character keys, displaying the Hiragana character displayed on the selected second character key at location of an insertion point and displaying, by the UI, the first keyboard.

A system can include a display device, processing circuitry, and a memory including instructions that, when executed by the processing circuitry, cause the processing circuitry to perform operations. The operations can include providing one or more signals to the display device that cause the display device to provide a view of a first keyboard including first character keys, the first character keys each including a respective Roman character and corresponding Hiragana characters displayed thereon. The operations can further include, in response to receiving one or more signals indicating a user selected a first character key of the first character keys, providing one or more signals to the display device that cause the display device to provide a view of a second keyboard including second character keys in place of the first keyboard, the second character keys including a respective Roman character and only one corresponding Hiragana character of the corresponding Hiragana characters displayed thereon. The operations can further include, in response to receiving one or more signals indicating a user selected a second character key of the second character keys, providing one or more signals to the display device that cause the display device to provide a view of the Hiragana character displayed on the second character at location of an insertion point and the first keyboard in place of the second keyboard.

At least one non-transitory machine-readable medium can include instructions that, when executed by a machine, cause the machine to perform operations. The operations can include providing one or more signals to a display device that cause the display device to provide a view of a first keyboard including first character keys, the first character keys each including a respective Roman character and corresponding Hiragana characters displayed thereon. The operations can further include, in response to receiving one or more signals indicating a user selected a first character key of the first character keys, providing one or more signals to the display device that cause the display device to provide a view of a second keyboard including second character keys in place of the first keyboard, the second character keys including a respective Roman character and only one corresponding Hiragana character of the corresponding Hiragana characters displayed thereon. The operations can further include, in response to receiving one or more signals indicating a user selected a second character key of the second character keys, providing one or more signals to the display device that cause the display device to provide a view of the Hiragana character displayed on the second character at location of an insertion point and the first keyboard in place of the second keyboard.

### BRIEF DESCRIPTION OF THE DRAWINGS

FIG. 1 illustrates, by way of example, a QWERTY keyboard, in accord with one or more embodiments.

FIG. 2 illustrates, by way of example, a perspective view diagram of an embodiment of a Romaji training input keyboard (RTIK).

FIG. 3 illustrates, by way of example, a perspective view diagram of an embodiment of a keyboard after a character key is selected.

FIG. 4 illustrates, by way of example, a perspective view diagram of an embodiment of a keyboard after a character key of the keyboard is selected.

FIG. 5 illustrates, by way of example, a perspective view diagram of an embodiment of a keyboard after a character key of the keyboard is selected.

FIG. 6 illustrates, by way of example, a state transition diagram detailing UI response to character key selections.

FIG. 7 illustrates, by way of example, a diagram of an embodiment of virtual keyboard and UI states and transitions between states.

FIG. 8 illustrates, by way of example, of an embodiment of UI states and transitions therebetween when a user is using a Japanese keyboard.

FIG. 9 illustrates, by way of example, a flow diagram of an embodiment of a method.

FIG. 10 is a block schematic diagram of a machine (e.g., a computer system) to implement one or more UIs discussed herein, according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims.

The operations, functions, or algorithms described herein may be implemented in software in some embodiments. The software may include computer executable instructions stored on computer or other machine-readable medium or storage device, such as one or more non-transitory memories or other type of hardware based storage devices, either local or networked. Further, such functions may correspond to subsystems, which may be software, hardware, firmware or a combination thereof. Multiple functions may be performed in one or more subsystems as desired, and the embodiments described are merely examples. The software may be executed on a digital signal processor, ASIC, microprocessor, central processing unit (CPU), graphics processing unit (GPU), field programmable gate array (FPGA), or other type of processor operating on a computer system, such as a personal computer, server or other computer system, turning such computer system into a specifically programmed machine. The functions or algorithms may be implemented using processing circuitry, such as may include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, logic gates, or the like) configured to perform one or more operations.

As discussed previously, Japanese characters can be “Romanized” by applying a Latin script to the language. This Romanization results in a Kana language representation called Romaji, or Roman letters. Hepburn romanization may be the most well-known form of Romaji. Other Japanese language representations include Hiragana and Katakana.

Romaji can help those unfamiliar with the Japanese characters learn how to pronounce the characters. A Romaji keyboard can help teach or train those that are unfamiliar with the Japanese characters, but that are familiar with Roman, usually Latin, characters and sounds, how to pronounce the Japanese characters.

There are currently at least two types of input methods of typing Japanese with a QWERTY keyboard. The input methods include Romaji input and Kana input. More users use the Romaji input method than the Kana input method. Understanding Romaji is essential to use Romaji input method.

Embodiments provide a Romaji input training keyboard and method that can be used without knowledge of Romaji, and train users' muscle memories to learn the Romaji input method. The keyboard can include extra key labels or key colors, such as on a regular QWERTY keyboard. The extra key labels can include Hiragana characters, and show users which Hiragana character to press to make the Romaji symbol or sound. The key colors can show users how many more keys need to be pressed to input characters in key labels. The key labels or colors can be dynamically changed as a user is typing.

A keyboard can be implemented as a virtual keyboard, a hardware keyboard, or a keyboard that is part hardware and part virtual, or the like. A virtual keyboard is one that is provided on a display, such as a touchscreen display. The virtual keyboard can be displayed and software, hardware, or firmware can control functionality of keys and the appearance of the keyboard on the screen. A hardware keyboard can have tactile feedback. A key on a hardware keyboard can include an optical device that projects a view of one or more characters. The one or more characters projected can be altered in response to a user selecting a key on the keyboard.

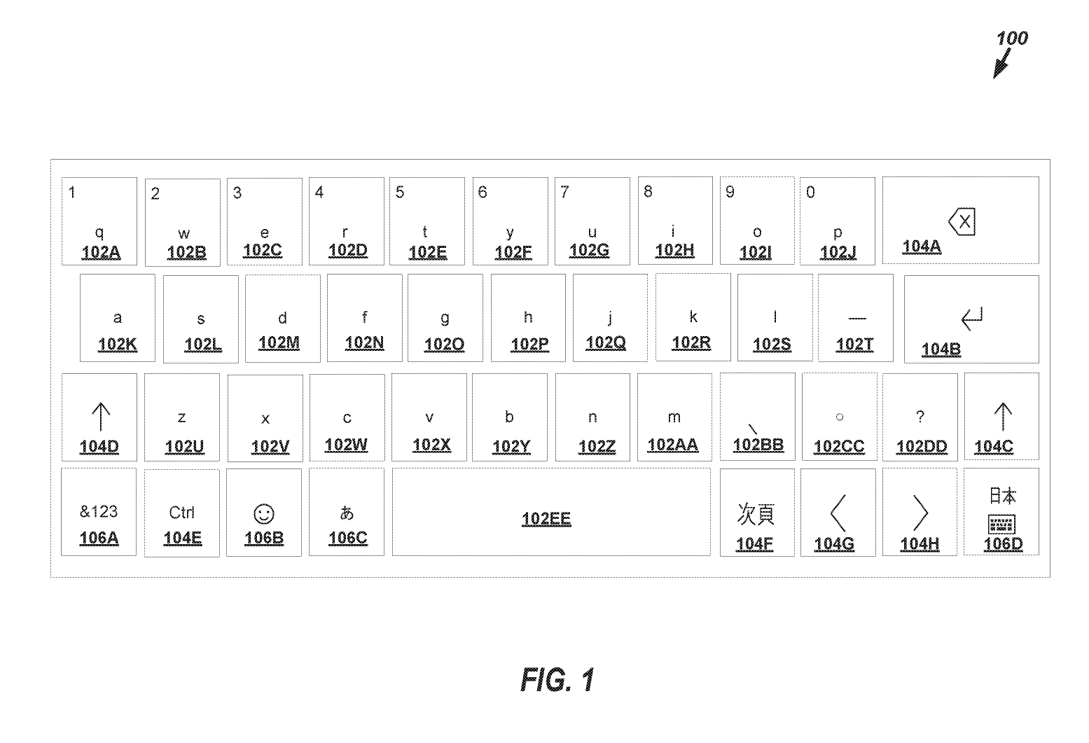

FIG. 1 illustrates, by way of example, a QWERTY keyboard 100, in accord with one or more embodiments. The QWERTY keyboard 100 as illustrated includes character keys 102A, 102B, 102C, 102D, 102E, 102F, 102G, 102H, 102I, 102J, 102K, 102L, 102M, 102N, 102O, 102P, 102Q, 102R, 102S 102T, 102U, 102V, 102W, 102X, 102Y, 102Z, 102AA, 102BB, 102CC, 102DD, and 102EE action keys 104A, 104B, 104C, 104D, 104E, 104F, 104G, and 104H, and conversion keys 106A, 106B, 106C, and 106D. The character keys 102A-102EE insert the corresponding Latin character or symbol when selected (e.g., pressed, touched, spoken, or the like). For example, in response to a user selecting the key 102L, the character “s” is displayed at a location of an insertion point (e.g., a flashing point cursor, not necessarily a location of a mouse cursor) of a user interface (UI). In another example, in response to a user selecting the key 102DD, the character “?” is displayed at a location of the insertion point of the UI.

The action keys 104A-104F perform an action on the insertion point or state of the character keys 102A-102EE keys. The action key 104A, for example, deletes a character immediately preceding an insertion point on the UI, in response to selection by the user. The action key 104B moves the insertion point, along with text after the insertion point, to a next line, in response to selection by the user (sometimes called a carriage return).

The action keys 104C-104D are sometimes called “shift” keys. In response to a user selecting the action key 104C-104D, the respective characters inserted in response to selection of the character key 102A-102CC are changed. For example, if a user selects the action key 104C, and while or after the action key 104C is selected, the character key 102A-102S and 102T-102AA, a capital version of the character associated with the character key 102A-102S or 102T-102AA is presented on the UI. Consider a user selecting the action key 104D and then selecting the character key 102AA. In such a case, the UI would display “M” at a location of the insertion point.

The action key 104E provides access to formatting functions, such as underline, bold, italics, insertion point movement, saving, open, close, content selection, character alignment, undo or redo previous operation, print, copy selected text or object, paste copied text or object, among other functions. For example, in a Word document, using MICROSOFT Word computer program, a user selects the action key 104E and then selects the character key 102K, all the contents of the Word document will be selected.

The action key 104F, when selected, allows a user to move an insertion point to a next page. Action keys 104G and 104H are sometimes referred to as arrow keys. A user can move an insertion point one space to the left by selecting the action key 104G. A user can move an insertion point one space to the right by selecting the action key 104H.

The conversion keys 106A, 106B, 106C, 106D, and 106E, when selected, alter the characters that can be selected for display on the UI. For example, the conversion key 106A, when selected alters the character keys 102A-102DD to be numerals and punctuation. The other conversion keys 106B-106E are similar, with the conversion key 106B altering the character keys 102A-102DD to be emojis, the conversion key 106C altering the character keys from Roman to Japanese, the conversion key 106D altering the character keys from characters of a first language to characters of a second language, such as French, Spanish, Russian, or the like.

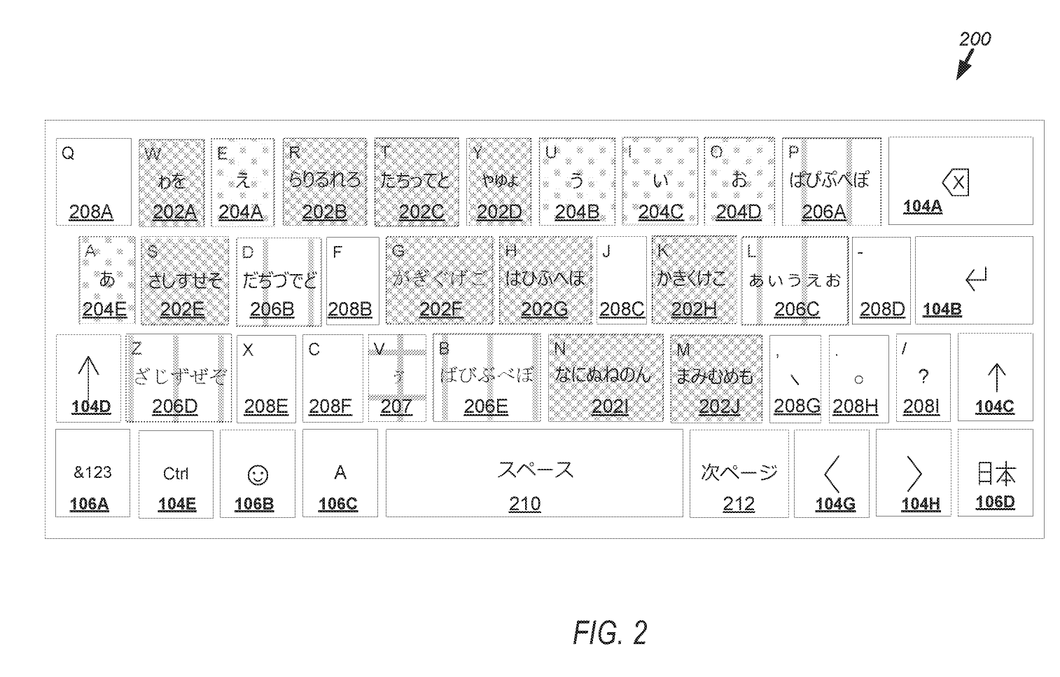

FIG. 2 illustrates, by way of example, a perspective view diagram of an embodiment of a Romaji training input keyboard (RTIK) 200. The RTIK 200 as illustrated includes Japanese Hiragana characters in place of Roman characters on some of the character keys 102A-102DD of the standard keyboard 100 with corresponding Roman characters moved to a different location on the character key 102A-102DD. A person familiar with Hiragana characters can use the keyboard 200 to type Romaji characters.

The keyboard 200 includes multiple input character keys 202A, 202B, 202C, 202D, 202E, 202F, 202G, 202H, 202I, and 202J, single input character keys 204A, 204B, 204C, 204D, and 204E, other multiple input character keys 206A, 206B, 206C. 206D, and 206E, a Katakana character input key 207, non-Hiragana input character keys 208A. 208B, 208C, 208D, 208E, 208F, 208G, 208H, and 208I, a space bar 210, and a next page key 212. The background style on the keys 202A-202J, 204A-204E, and 206A-206E represent the different functionality of the keys. The different background styles can include different colors, lights, shading, patterns, images, or the like. The different background styles can be presented to the user. A user can alter the background style to their preferred background style, or even eliminate the background style.

Compared to the keys of the keyboard 100, the corresponding keys of the keyboard 200 can be wider, narrower, or the same width. The width of the keys of the keyboard 200 can be sized to accommodate the number of Hiragana characters present on the corresponding key. For example, a key of the keyboard 200 that includes four or more Hiragana characters thereon, can be wider than the corresponding key on the keyboard 100.

The keys 202A-202J are shaded differently to indicate that they are multiple-input characters. The keys 202A-202J each include the Hiragana characters displayed thereon that can be inserted into a file by, in part, selecting the respective key 202A-202J. For example, to insert the character “ [symbol] ” a user first selects the character key 202H. In another example, to insert the character “ [symbol] ” a user first selects the character key 202E.

In response to the user selecting one of the character keys 202A-202J or 206A-206E, the characters displayed on the keys 202A-202J, 204A-204E, and 206A-206E can be changed. The characters displayed on the keys 202A-202J. 204A-204E, and 206A-206E can be changed to indicate which Hiragana symbol may be inserted on the UI, in response to selecting a key.

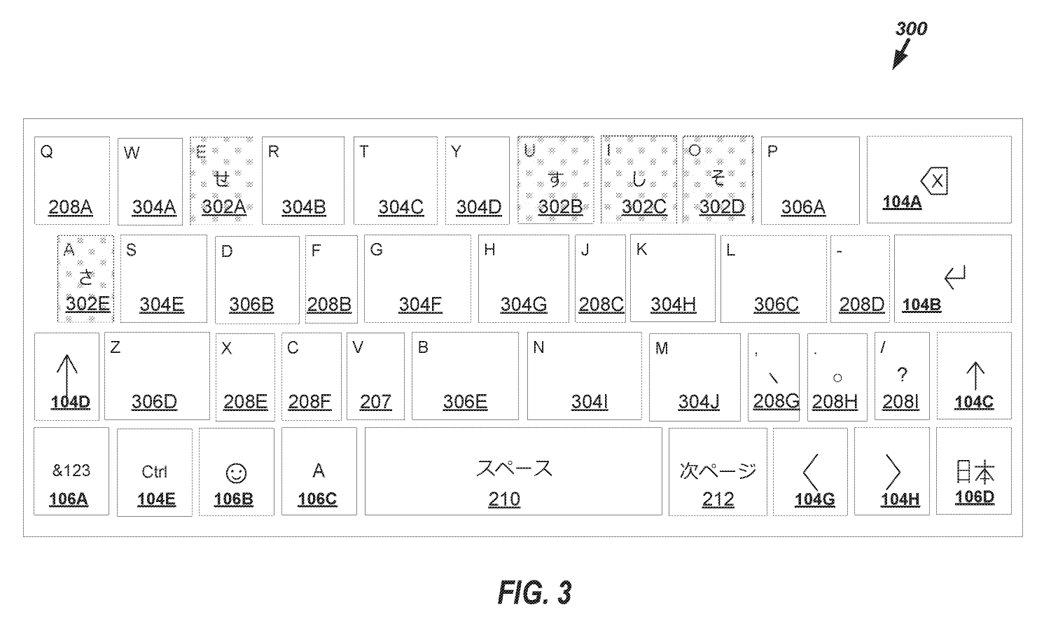

FIG. 3 illustrates, by way of example, a perspective view diagram of an embodiment of a keyboard 300 after the character key 202E is selected. With reference to the keyboard 200 of FIG. 2, the characters “ [symbol] ”, “ [symbol] ”, “ [symbol] ”, “ [symbol] ”, and “ [symbol] ” can be inserted by a user, at least in part, selecting the key 202E. The keyboard 300 includes each of the characters “ [symbol] ”, “ [symbol] ”, “ [symbol] ”, “ [symbol] ”, and “ [symbol] ” on respective keys 302A, 302B. 302C, 302D, and 302E. Each of the character keys 302A-302E of the keyboard 300 include the same shading as the keys 204A-204E (e.g., on the keyboard 200). Other keys 304A. 304B, 304C, 304D, 304E, 304F, 304G, 304H, 304I, 304J, 306A, 306B, 306C, 306D, and 306E, of the keyboard 300, however, have different shading than the corresponding keys 202A-J and 206A-206E (e.g., of the keyboard 200).

The keys 302A-302E include a background style that indicates that only a single key selection is required to input the Hiragana character shown on the key. For example, if a user selects the key 302C of the keyboard 300, the character “ [symbol] ” is inserted at a location of the insertion point on the UI. Thus, to input the character “ [symbol] ” the user first selects the character 202E of the keyboard 200 and then selects the character key 302C of the keyboard 300; to input the character “ [symbol] ”, the user first selects the character 202E of the keyboard 200 and then selects the character key 302A of the keyboard 300; and so on. In response to the user selecting one of the keys 302A-302E, the keyboard 200 is shown in place of the keyboard 300.

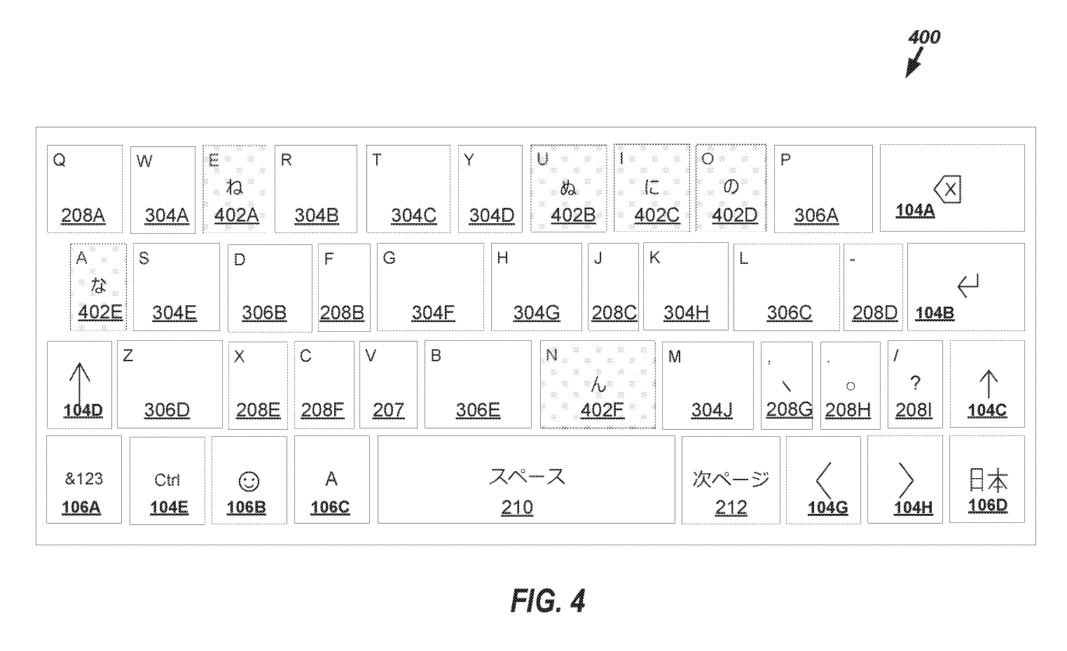

FIG. 4 illustrates, by way of example, a perspective view diagram of an embodiment of a keyboard 400 after the character key 202I of the keyboard 200 is selected. With reference to the keyboard 200 of FIG. 2, the characters “ [symbol] ”, “ [symbol] ”, “ [symbol] ”, “ [symbol] ”, “ [symbol] ”, and “ [symbol] ” can be inserted by a user, at least in part, selecting the key 202I. The keyboard 400 includes each of the characters “ [symbol] ”, “ [symbol] ”, “ [symbol] ”, “ [symbol] ”, “ [symbol] ”, and “ [symbol] ” on respective keys 402A, 402B. 402C, 402D, 402E, and 402F. Each of the character keys 402A-402F of the keyboard 400 include the same shading as the keys 204A-204E (e.g., on the keyboard 200). Other keys 304A-304H, 304J, and 306A-306E of the keyboard 400, however, have different shading than the corresponding keys 202A-J and 206A-206E (e.g., of the keyboard 200).

The keys 402A-402E include a background style that indicates that only a single key selection is required to input the Hiragana character shown on the key. For example, if a user selects the key 402F of the keyboard 400, the character “ [symbol] ” is inserted at a location of the insertion point on the UI. Thus, to input the character “ [symbol] ” the user first selects the character 202I of the keyboard 200 and then selects the character key 402F of the keyboard 400; to input the character “ [symbol] ”, the user first selects the character 202I of the keyboard 200 and then selects the character key 402D of the keyboard 400; and so on. In response to the user selecting one of the keys 402A-402F, the keyboard 200 is shown in place of the keyboard 400.

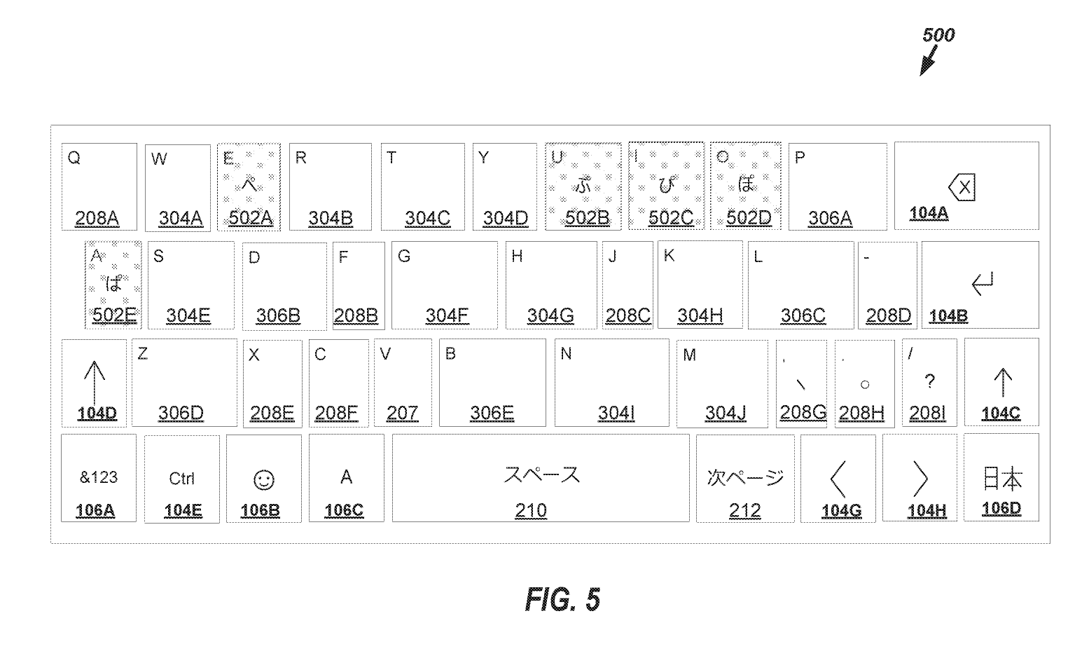

FIG. 5 illustrates, by way of example, a perspective view diagram of an embodiment of a keyboard 500 after the character key 206A of the keyboard 200 is selected. With reference to the keyboard 200 of FIG. 2, the characters “ [symbol] ”, “ [symbol] ”, “ [symbol] ”, “ [symbol] ”, and “ [symbol] ” can be inserted by a user, at least in part, selecting the key 206A. The keyboard 500 includes each of the characters “ [symbol] ”, “ [symbol] ”, “ [symbol] ”, and “ [symbol] ” on respective keys 502A, 502B, 502C, 502D, and 502E. Each of the character keys 502A-502E of the keyboard 500 include the same background style as the keys 204A-204E (e.g., on the keyboard 200). Other keys 304A-304J and 306A-306E of the keyboard 500, however, have different shading than the corresponding keys 202A-J and 206A-206E (e.g., of the keyboard 200).

The keys 502A-5402E include a background style that indicates that only a single key selection is required to input the Hiragana character shown on the key. For example, if a user selects the key 502E of the keyboard 500, the character “ [symbol] ” is inserted at a location of the insertion point on the UI. Thus, to input the character “ [symbol] ” the user first selects the character key 206A of the keyboard 200 and then selects the character key 502E of the keyboard 500; to input the character “ [symbol] ”, the user first selects the character key 206A of the keyboard 200 and then selects the character key 502B of the keyboard 500; and so on. In response to the user selecting one of the keys 502A-502E, the keyboard 200 is shown in place of the keyboard 500.

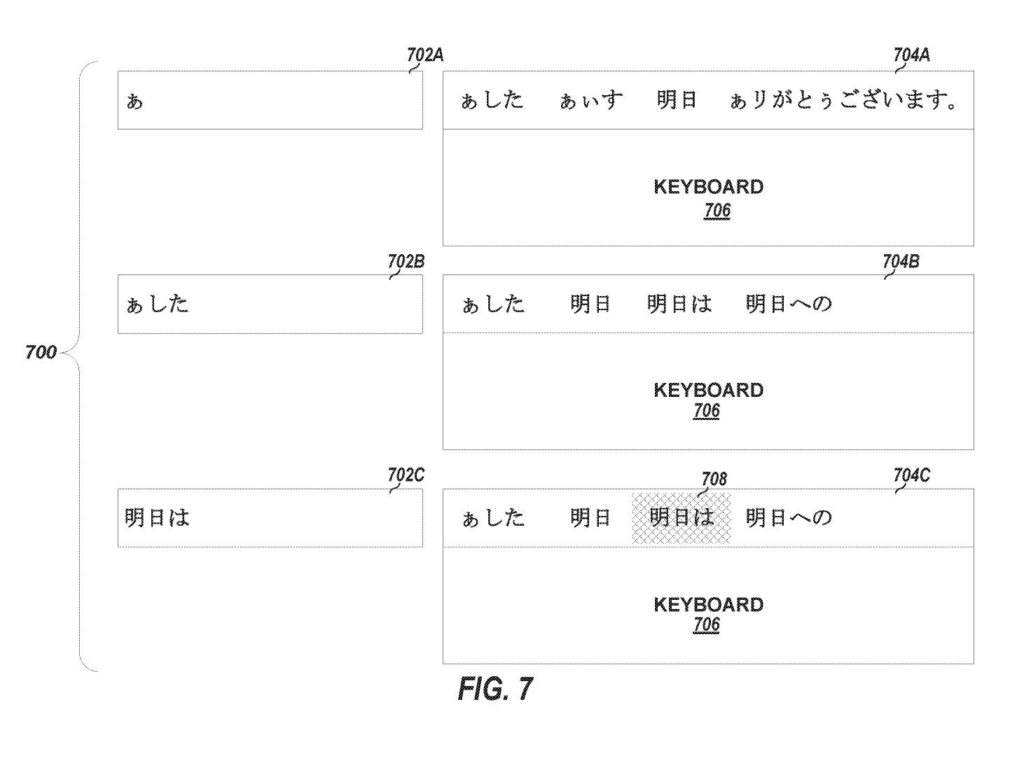

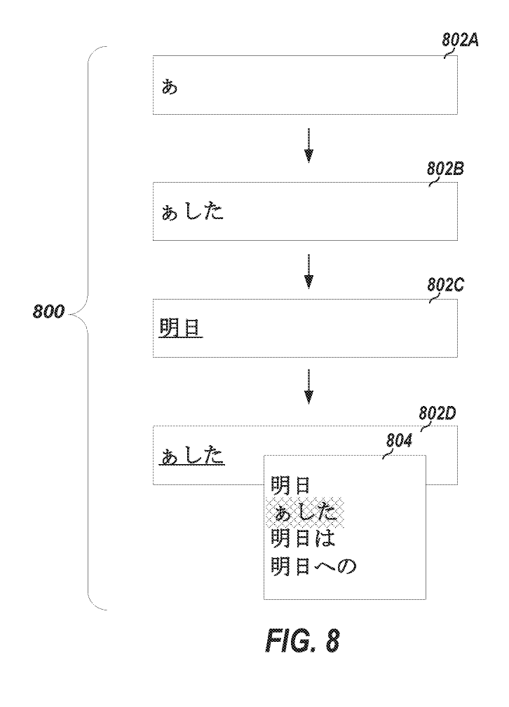

The space bar 210 of the keyboards 200-500 operates differently than the space bar of the keyboard 100 (e.g., the null character key 102EE). The space bar 210, in addition to inserting the null character at a location of the insertion point and advancing the insertion point one space to the right, can indicate that Hiragana characters are to be converted to one or more other characters. A user can select character keys, such as in a manner discussed regarding FIGS. 2-5 to enter the “ [symbol] , [symbol] , [symbol] ”, and after the user presses the space bar 210 the text can be converted to [symbol] , [symbol] , such as can be dependent on a number of times the user presses the space bar 210. FIGS. 7-8 describe, in more detail, operations of the space bar 210 on virtual and hardware keyboards.

The character keys 208A, 208B, 208C, 208D, 208E, 208F, 208G, 208H, and 208I can be active or inactive. An active key, in response to being selected, inserts the character on the key at the current location of the insertion point. An inactive key, in response to being selected, has no effect on a document or UI.

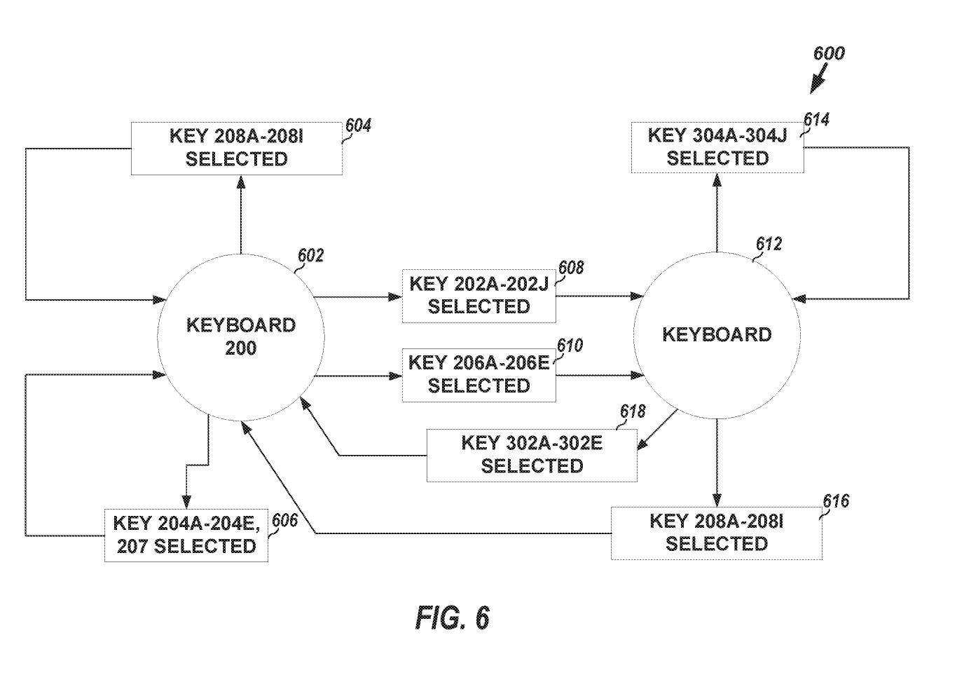

FIG. 6 illustrates, by way of example, a state transition diagram 600 detailing UI response to character key selections. A state 602 includes the keyboard 200 displayed on the UI. At state 604, one of the keys 208A-208I is selected. The character corresponding to the selected key is inserted at a location of an insertion point and the UI retains the keyboard in the state 602. At state 606, one of the keys 204A-204E and 207 is selected. The character corresponding to the selected key is inserted at a location of the insertion point and the UI retains the keyboard in the state 602.

At state 608, one of the keys 202A-202J is selected. The character corresponding to the selected key is inserted at a location of the insertion point and the UI transitions the keyboard to the state 612. The UI in state 612 can look like the keyboard 300, 400 or similar. At state 610, one of the keys 206A-206E is selected. The character corresponding to the selected key is inserted at a location of the insertion point and the UI transitions the keyboard to the state 612. The UI in state 612 can look like the keyboard 500 or similar.

While in the state 612, and in response to a user selecting the key 304A-304J in state 614, the character corresponding to the selected key is inserted at a location of the insertion point and the UI retains the keyboard in the state 612. While in the state 612, and in response to a user selecting the key 208A-208I in state 616, the character corresponding to the selected key is inserted at a location of the insertion point and the UI transitions the keyboard to the state 602. While in the state 612, and in response to a user selecting the key 302A-302E in state 618, the character corresponding to the selected key is inserted at a location of the insertion point and the UI transitions the keyboard to the state 602.

TABLE 1
Summary of example UI/keyboard functionality

| | | | Sample strings in target |
|---|---|---|---|
| User Action | | Target Text Field State | text field in the state |
| 1. | Select key 204A- | New Hiragana character is | [symbol] |
| | 204E, 302A- | completed or inserted. | [symbol] |
| | 302E, 402A- | | [symbol] |
| | 402F, or 502A- | | nps [symbol] |
| | 502E | | |
| 2. | Select key | A fragment of key sequence | k |
| | 202A-202J | to input a Hiragana | [symbol] m |
| | | character (e.g., in the | |
| | | Japanese syllabary) is | |
| | | inserted. | |
| 3. | Select key | A fragment of key sequence | z |
| | 206A-206E | to input a Hiragana | [symbol] p |
| | | character (e.g., Dakuon, | xd |
| | | Han-dakuon, Youon, or | |
| | | other) is inserted. | |
| 4. | Select key | An alphabet character which | x |
| | 208A-208I | cannot construct a key | [symbol] c |
| | | sequence to input a | |
| | | Hiragana character is | |
| | | inserted. | |
| 5. | Select key 304A- | A fragment of key sequence | Sn |
| | 304J, 306A-306E | remains. At the same time, a | [symbol] dg |
| | | fragment of key sequence to | [symbol] ns |
| | | input a Hiragana character | |
| | | is inserted. | |
| 6. | Select key 208A- | A fragment of key sequence | [symbol] sx |
| | 208I of keyboard | remains. Also, an alphabet | Sc |
| | 300, 400, 500, or | character which cannot | [symbol] f |
| | similar keyboard | construct a key sequence to | |
| | from state 612 | input a Hiragana character. | |

FIG. 7 illustrates, by way of example, a diagram of an embodiment of virtual keyboard and UI states 700 and transitions therebetween. The states 700 as illustrated include a UI 702A in a first state and a keyboard 706 with a header 704A in first state. The keyboard 706 can include the keyboard 200, 300, 400, or the like, depending on the character key that has been selected. The UI 702A includes a view after a first character “ [symbol] ” is selected. The header 704A includes type-ahead predictions. The type-ahead predictions are strings of characters predicting what the user is going to input.

The UI 702B includes the UI 702A after a few more characters “ [symbol] ” have been selected. A header 704B of the keyboard 706 is updated to include predictions of strings of characters based on the additional selected characters. The UI 702C illustrates a resultant state of the UI 702B after a user selects the space bar 210 three times. The third predicted string of characters 708 in the header 704C is highlighted and that string of characters is displayed in place of one or more previously typed characters in the UI 702C.

FIG. 8 illustrates, by way of example, of an embodiment of UI states 800 and transitions therebetween when a user is using a Japanese keyboard. The UIs 802A and 802B are the same as the UIs 702A-702B, respectively, of the states 700. The UI 802A is displayed after the character “ [symbol] ” is selected. The UI 802B is displayed after a few more characters “ [symbol] ” have been selected.

The UI 802C can be displayed after a user selects the space bar 210 of a hardware keyboard. The characters “ [symbol] ” are a first predicted string of characters. The UI 802D can be displayed after a user selects the space bar 210 a second, consecutive time (after the UI 802B is displayed). A list of predicted character strings 804 is presented in response to the second, consecutive space bar 210 selection. A user can navigate down the list using arrow keys or the space bar 804. The predicted character strings 704A-704C or 804 can include Kanji. Hiragana, Katakana, or a combination of Hiragana and Kanji

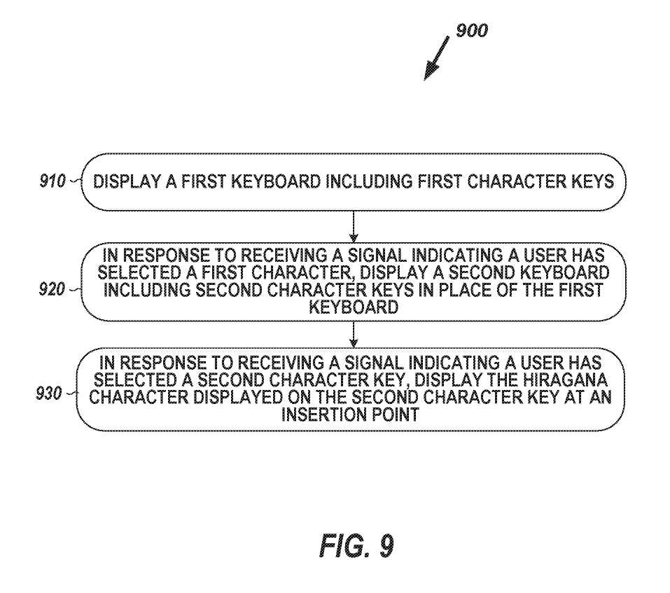

FIG. 9 illustrates, by way of example, a flow diagram of an embodiment of a method 900. The method 900 can be for training a user to use a keyboard to type Romaji Japanese characters. The method 900 as illustrated includes displaying, by a user interface (UI) of a device, a first keyboard including first character keys, at operation 902; in response to receiving one or more signals indicating a user has selected a first character key of the first character keys, displaying a second keyboard including second character keys in place of the first keyboard, at operation 904; and in response to receiving one or more signals indicating a user has selected a second character key of the second character keys, displaying the Hiragana character displayed on the selected second character key at location of an insertion point and displaying, at operation 906. The first character keys can each include a respective Roman character and corresponding Hiragana characters displayed thereon. The second character keys can include a respective Roman character and only one corresponding Hiragana character of the corresponding Hiragana characters displayed thereon. The method 900 can further include, in response to receiving the signal indicating the user selected the second character key, displaying, by the UI, the first keyboard.

The method 900 can further include displaying, on the UI, the first character keys over a first background style and displaying third character keys of the first keyboard over a second background style different from the first background style. The first background style can include a first color and the second background style includes a second, different color. The third character keys can include a respective Roman character and only one corresponding Hiragana character displayed thereon. The method 900 can further include, in response to receiving one or more signals indicating a user has selected a third character key of the third character keys, displaying the Hiragana character of the selected third character key at the location of the insertion point.

The method 900 can further include displaying, by the UI, fourth character keys on the first keyboard, the fourth character keys including a single Roman character and no Hiragana characters displayed thereon. The method 900 can further include displaying, by the UI, the fourth character keys over a third background style, the third back ground different from the first and the second background styles. The method 900 can further include displaying, by the UI, fifth character keys on the first keyboard, the first character keys including a Roman character and multiple Hiragana characters displayed thereon.

The method 900 can further include, wherein the Hiragana characters on the first character keys are in a Japanese syllabary and the Hiragana characters on the fifth character keys are not in the Japanese syllabary. The method 900 can further include, after displaying the Hiragana character displayed on the second character and in response to receiving one or more signals indicating the user has selected a space bar key, displaying, in place of the Hiragana character, an equivalent Kanji character.

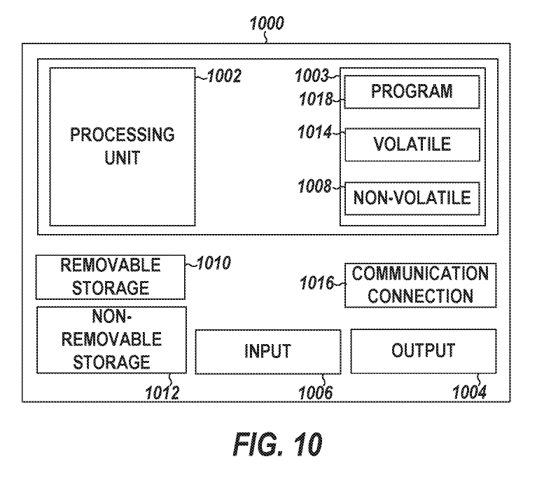

FIG. 10 is a block schematic diagram of a machine 1000 (e.g., a computer system) to implement one or more UIs discussed herein, according to example embodiments. One example machine 1000 (in the form of a computer), may include a processing unit 1002, memory 1003, removable storage 1010, and non-removable storage 1012. Although the example computing device is illustrated and described as machine 1000, the computing device may be in different forms in different embodiments. For example, the computing device may instead be a smartphone, a tablet, smartwatch, or other computing device including the same or similar elements as illustrated and described regarding FIG. 10. Devices such as smartphones, tablets, and smartwatches are generally collectively referred to as mobile devices. Further, although the various data storage elements are illustrated as part of the machine 1000, the storage may also or alternatively include cloud-based storage accessible via a network, such as the Internet.

Memory 1003 may include volatile memory 1014 and non-volatile memory 1008. The machine 1000 may include—or have access to a computing environment that includes—a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1000 may include or have access to a computing environment that includes input 1006, output 1004, and a communication connection 1016. Output 1004 may include a display device, such as a touchscreen, that also may serve as an input device. The input 1006 may include one or more of a touchscreen, touchpad, mouse, keyboard, camera, one or more device-specific buttons, one or more sensors integrated within or coupled via wired or wireless data connections to the machine 1000, and other input devices. The computer may operate in a networked environment using a communication connection to connect to one or more remote computers, such as database servers, including cloud based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi). Bluetooth, or other networks.

Computer-readable instructions stored on a computer-readable storage device are executable by the processing unit 1002 of the machine 1000. A hard drive, CD-ROM, and RAM are some examples of articles including a non-transitory computer-readable medium such as a storage device. For example, a computer program 1018 may be used to cause processing unit 1002 to perform one or more methods or algorithms described herein. The processing unit 1002 can receive one or more signals from a touchscreen or a keyboard and provide one or more signals to the touchscreen or keyboard to perform operations of the method 900 or other techniques discussed herein.

### Additional Notes and Examples

Example 1 includes a method for training a user to type Romaji Japanese characters, the method comprising displaying, by a user interface (UI) of a device, a first keyboard including first character keys, the first character keys each including a respective Roman character and corresponding Hiragana characters displayed thereon, in response to receiving one or more signals indicating a user selected a first character key of the first character keys, displaying a second keyboard including second character keys in place of the first keyboard, the second character keys including a respective Roman character and only one corresponding Hiragana character of the corresponding Hiragana characters displayed thereon, and in response to receiving one or more signals indicating a user selected a second character key of the second character keys, displaying the Hiragana character displayed on the selected second character key at location of an insertion point and displaying, by the UI, the first keyboard.

In Example 2, Example 1 can further include displaying, on the UI, the first character keys over a first background style and displaying third character keys of the first keyboard over a second background style different from the first background style.

In Example 3, Example 2 can further include, wherein the first background style includes a first color and the second background style includes a second, different color.

In Example 4, at least one of Examples 2-3 can further include, wherein the third character keys include a respective Roman character and only one corresponding Hiragana character displayed thereon, and the method further includes in response to receiving one or more signals indicating a user selected a third character key of the third character keys, displaying the Hiragana character of the selected third character key at the location of the insertion point.

In Example 5, at least one of Examples 2-4 can further include displaying, by the UI, fourth character keys on the first keyboard, the fourth character keys including a single Roman character and no Hiragana characters displayed thereon.

In Example 6, Example 5 can further include displaying, by the UI, the fourth character keys over a third background style, the third back ground different from the first and the second background styles.

In Example 7, Example 6 can further include displaying, by the UI, fifth character keys on the first keyboard, the first character keys including a Roman character and multiple Hiragana characters displayed thereon.

In Example 8, Example 7 can further include, wherein the Hiragana characters on the first character keys are in a Japanese syllabary and the Hiragana characters on the fifth character keys are not in the Japanese syllabary.

In Example 9, at least one of Examples 7-8 can further include after displaying the Hiragana character displayed on the second character and in response to receiving one or more signals indicating the user selected a space bar key, displaying, in place of the Hiragana character, an equivalent Kanji character.

Example 10 can include a system comprising a display device, processing circuitry, a memory including instructions that, when executed by the processing circuitry, cause the processing circuitry to perform operations comprising providing one or more signals to the display device that cause the display device to provide a view of a first keyboard including first character keys, the first character keys each including a respective Roman character and corresponding Hiragana characters displayed thereon, in response to receiving one or more signals indicating a user selected a first character key of the first character keys, providing one or more signals to the display device that cause the display device to provide a view of a second keyboard including second character keys in place of the first keyboard, the second character keys including a respective Roman character and only one corresponding Hiragana character of the corresponding Hiragana characters displayed thereon, and in response to receiving one or more signals indicating a user selected a second character key of the second character keys, providing one or more signals to the display device that cause the display device to provide a view of the Hiragana character displayed on the second character at location of an insertion point and the first keyboard in place of the second keyboard.

In Example 11, Example 10 can further include, wherein the operations further comprise providing one or more signals to the display device that cause the display device to provide a view of the first character keys over a first background style and third character keys of the first keyboard over a second background style different from the first background style.

In Example 12, Example 11 can further include, wherein the first background style includes a first color and the second background style includes a second, different color.

In Example 13, at least one of Examples 11-12 can further include, wherein the third character keys include a respective Roman character and only one corresponding Hiragana character displayed thereon, and the operations further comprise, in response to receiving one or more signals indicating a user selected a third character key of the third character keys, providing one or more signals to the display device that cause the display device to provide a view of the Hiragana character of the selected third character key at the location of the insertion point.

In Example 14, at least one of Examples 11-13 can further include providing one or more signals to the display device that cause the display device to provide a view of fourth character keys on the first keyboard, the fourth character keys including a single Roman character and no Hiragana characters displayed thereon.

Example 15 can include at least one non-transitory machine-readable medium, including instructions that, when executed by a machine, cause the machine to perform operations comprising providing one or more signals to a display device that cause the display device to provide a view of a first keyboard including first character keys, the first character keys each including a respective Roman character and corresponding Hiragana characters displayed thereon, in response to receiving one or more signals indicating a user selected a first character key of the first character keys, providing one or more signals to the display device that cause the display device to provide a view of a second keyboard including second character keys in place of the first keyboard, the second character keys including a respective Roman character and only one corresponding Hiragana character of the corresponding Hiragana characters displayed thereon, and in response to receiving one or more signals indicating a user selected a second character key of the second character keys, providing one or more signals to the display device that cause the display device to provide a view of the Hiragana character displayed on the second character at location of an insertion point and the first keyboard in place of the second keyboard.

In Example 16, Example 15 can further include instructions that, when executed by a machine, cause the machine to perform operations comprising providing one or more signals to the display device that cause the display device to provide a view of the first character keys over a first background style and third character keys of the first keyboard over a second background style different from the first background style, and providing one or more signals to the display device that cause the display device to provide a view of the fourth character keys on the first keyboard, the fourth character keys including a single Roman character and no Hiragana characters displayed thereon.

In Example 17, Example 16 can further include instructions that, when executed by a machine, cause the machine to perform operations comprising providing one or more signals to the display device that cause the display device to provide a view of the fourth character keys over a third background style, the third back ground different from the first and the second background styles.

In Example 18, at least one of Examples 16-17 can further include instructions that, when executed by a machine, cause the machine to perform operations comprising providing one or more signals to the display device that cause the display device to provide a view of fifth character keys on the first keyboard, the first character keys including a Roman character and multiple Hiragana characters displayed thereon.

In Example 19, Example 18 can further include, wherein the Hiragana characters on the first character keys are in a Japanese syllabary and the Hiragana characters on the fifth character keys are not in the Japanese syllabary.

In Example 20, at least one of Examples 18-19 can further include instructions that, when executed by a machine, cause the machine to perform operations comprising, after displaying the Hiragana character displayed on the second character and in response to receiving one or more signals indicating the user selected a space bar key, providing one or more signals to the display device that cause the display device to provide a view of, in place of the Hiragana character, an equivalent Kanji character.

Although a few embodiments have been described in detail above, other modifications are possible. For example, the logic flows depicted in the figures do not require the order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A method for training a user to type Romaji Japanese characters, the method comprising:
displaying, by a user interface (UI) of a device, a first keyboard including first character keys, the first character keys each including a respective Roman character and corresponding Hiragana characters displayed thereon;
in response to receiving one or more signals indicating a user selected a first character key of the first character keys, displaying a second keyboard including second character keys in place of the first keyboard, the second character keys including a respective Roman character and only one corresponding Hiragana character of the corresponding Hiragana characters displayed thereon; and
in response to receiving one or more signals indicating a user selected a second character key of the second character keys, displaying the Hiragana character displayed on the selected second character key at location of an insertion point and displaying, by the UI, the first keyboard.

2. The method of claim 1, further comprising:
displaying, on the UI, the first character keys over a first background style and displaying third character keys of the first keyboard over a second background style different from the first background style.

3. The method of claim 2, wherein the first background style includes a first color and the second background style includes a second, different color.

4. The method of claim 2, wherein:
the third character keys include a respective Roman character and only one corresponding Hiragana character displayed thereon; and
the method further includes in response to receiving one or more signals indicating a user selected a third character key of the third character keys, displaying the Hiragana character of the selected third character key at the location of the insertion point.

5. The method of claim 2, further comprising:
displaying, by the UI, fourth character keys on the first keyboard, the fourth character keys including a single Roman character and no Hiragana characters displayed thereon.

6. The method of claim 5, further comprising:
displaying, by the UI, the fourth character keys over a third background style, the third back ground different from the first and the second background styles.

7. The method of claim 6, further comprising:
displaying, by the UI, fifth character keys on the first keyboard, the first character keys including a Roman character and multiple Hiragana characters displayed thereon.

8. The method of claim 7, wherein the Hiragana characters on the first character keys are in a Japanese syllabary and the Hiragana characters on the fifth character keys are not in the Japanese syllabary.

9. The method of claim 7, further comprising:
after displaying the Hiragana character displayed on the second character and in response to receiving one or more signals indicating the user selected a space bar key, displaying, in place of the Hiragana character, an equivalent Kanji character.

10. A system comprising:
a display device;
processing circuitry;
a memory including instructions that, when executed by the processing circuitry, cause the processing circuitry to perform operations comprising:
providing one or more signals to the display device that cause the display device to provide a view of a first keyboard including first character keys, the first character keys each including a respective Roman character and corresponding Hiragana characters displayed thereon;
in response to receiving one or more signals indicating a user selected a first character key of the first character keys, providing one or more signals to the display device that cause the display device to provide a view of a second keyboard including second character keys in place of the first keyboard, the second character keys including a respective Roman character and only one corresponding Hiragana character of the corresponding Hiragana characters displayed thereon; and
in response to receiving one or more signals indicating a user selected a second character key of the second character keys, providing one or more signals to the display device that cause the display device to provide a view of the Hiragana character displayed on the second character at location of an insertion point and the first keyboard in place of the second keyboard.

11. The system of claim 10, wherein the operations further comprise:
providing one or more signals to the display device that cause the display device to provide a view of the first character keys over a first background style and third character keys of the first keyboard over a second background style different from the first background style.

12. The system of claim 11, wherein the first background style includes a first color and the second background style includes a second, different color.

13. The system of claim 11, wherein:
the third character keys include a respective Roman character and only one corresponding Hiragana character displayed thereon; and
the operations further comprise, in response to receiving one or more signals indicating a user selected a third character key of the third character keys, providing one or more signals to the display device that cause the display device to provide a view of the Hiragana character of the selected third character key at the location of the insertion point.

14. The method of claim 11, further comprising:
providing one or more signals to the display device that cause the display device to provide a view of fourth character keys on the first keyboard, the fourth character keys including a single Roman character and no Hiragana characters displayed thereon.

15. At least one non-transitory machine-readable medium, including instructions that, when executed by a machine, cause the machine to perform operations comprising:
providing one or more signals to a display device that cause the display device to provide a view of a first keyboard including first character keys, the first character keys each including a respective Roman character and corresponding Hiragana characters displayed thereon;
in response to receiving one or more signals indicating a user selected a first character key of the first character keys, providing one or more signals to the display device that cause the display device to provide a view of a second keyboard including second character keys in place of the first keyboard, the second character keys including a respective Roman character and only one corresponding Hiragana character of the corresponding Hiragana characters displayed thereon; and
in response to receiving one or more signals indicating a user selected a second character key of the second character keys, providing one or more signals to the display device that cause the display device to provide a view of the Hiragana character displayed on the second character at location of an insertion point and the first keyboard in place of the second keyboard.

16. The at least one non-transitory machine-readable medium of claim 15, further including instructions that, when executed by a machine, cause the machine to perform operations comprising:
providing one or more signals to the display device that cause the display device to provide a view of the first character keys over a first background style and third character keys of the first keyboard over a second background style different from the first background style; and
providing one or more signals to the display device that cause the display device to provide a view of the fourth character keys on the first keyboard, the fourth character keys including a single Roman character and no Hiragana characters displayed thereon.

17. The at least one non-transitory machine-readable medium of claim 16, further including instructions that, when executed by a machine, cause the machine to perform operations comprising providing one or more signals to the display device that cause the display device to provide a view of the fourth character keys over a third background style, the third back ground different from the first and the second background styles.

18. The at least one non-transitory machine-readable medium of claim 16, further including instructions that, when executed by a machine, cause the machine to perform operations comprising providing one or more signals to the display device that cause the display device to provide a view of fifth character keys on the first keyboard, the first character keys including a Roman character and multiple Hiragana characters displayed thereon.

19. The at least one non-transitory machine-readable medium of claim 18, wherein the Hiragana characters on the first character keys are in a Japanese syllabary and the Hiragana characters on the fifth character keys are not in the Japanese syllabary.

20. The at least one non-transitory machine-readable medium of claim 18, further including instructions that, when executed by a machine, cause the machine to perform operations comprising, after displaying the Hiragana character displayed on the second character and in response to receiving one or more signals indicating the user selected a space bar key, providing one or more signals to the display device that cause the display device to provide a view of, in place of the Hiragana character, an equivalent Kanji character.
